(19) United States
(12) Patent Application Publication
(10) Pub. No.: US 2013/0204938 A1
(43) Pub. Date: Aug. 8, 2013

(54) METHOD AND APPARATUS FOR SHARING INFORMATION ABOUT USE OF CONTENT USING MACHINE-TO-MACHINE COMMUNICATION

(71) Applicant: Dong-Hwan SON, Daejeon (KR)

(72) Inventor: Dong-Hwan SON, Daejeon (KR)

(73) Assignee: ELECTRONICS AND TELECOMMUNICATIONS RESEARCH INSTITUTE, Daejeon (KR)

(21) Appl. No.: 13/610,386

(22) Filed: Sep. 11, 2012

(30) Foreign Application Priority Data
Feb. 6, 2012 (KR) 10-2012-0011667

(51) Int. Cl. G06F 15/16

(52) U.S. Cl. 709/204

(57) ABSTRACT

Disclosed herein are a method and apparatus for sharing information about the use of content. The apparatus includes a first communication unit, a second communication unit, a storage unit, and a control unit. The first communication unit establishes communication between at least one content terminal and a first user terminal over an M2M network. The second communication unit exchanges data with a predetermined server. The storage unit receives information about the use of content being consumed in the content terminal from the content terminal via the first communication unit, and stores it. The control unit sends the received information about the use of content to a predetermined server via the second communication unit, thereby allowing the information about the use of content to be stored in the server.

### CROSS-REFERENCE TO RELATED APPLICATION

This application claims the benefit of Korean Patent Application No. 10-2012-0011667, filed on Feb. 6, 2012, which is hereby incorporated by reference in its entirety into this application.

### BACKGROUND OF THE INVENTION

1. Technical Field

The present invention relates generally a method and apparatus for sharing information about the use of content over a network and, more particularly, to a method and apparatus for sharing information about the use of content, which is capable of, in a communication system for transmitting and receiving broadcasts and content data over a network between terminals, sharing the information about the use of content of each user and transmitting messages.

2. Description of the Related Art

Current users consume content from a variety of content terminals such as various television stations and computers, and they desire to share information about the content they are consuming with surrounding acquaintances over a network in real time.

Furthermore, with the development of communication technology, mobile terminals, such as smart phones and Personal Digital Assistants (PDAs), that are equipped with a variety of functions and can receive and send data over a network have been popularized among individual users. Such mobile terminals correspond to personalized devices into each of which a variety of information and the characteristics of each user have been incorporated.

However, conventional mobile terminals can connect to a content terminal and exchange data with the content terminal, but do not have the function of sharing information about the use of content with another mobile terminal. That is, although the conventional mobile terminals are connected to each other over a network, they are problematic in that the users' desire to provide the desired information to some other user cannot be fulfilled.

Accordingly, the present invention proposes a technology that is capable of transmitting and sharing information about the use of content by user terminals.

### SUMMARY OF THE INVENTION

Accordingly, the present invention has been made keeping in mind the above problems occurring in the prior art, and an object of the present invention is to provide a method and apparatus which, when a user is consuming content via a content terminal such as a television set or a digital versatile disc (DVD) player, send information related to the content to another network communication-enabled user terminal, send and store the information to and in a server connected via the Internet, and enable the information to be shared with some other users.

In order to accomplish the above object, the present invention provides a method of sharing information about the use of content, including establishing, by a first user terminal, communication between at least one content terminal and the first user terminal over a machine-to-machine (M2M) network; receiving, by the first user terminal, information about use of content being consumed in the content terminal from the content terminal; and sending, by the first user terminal, the received information about the use of content to a predetermined server over an Internet, thereby allowing the information about the use of content to be stored in the server.

In order to accomplish the above object, the present invention provides an apparatus for sharing information about the use of content, including a first communication unit for establishing communication between at least one content terminal and a first user terminal over an M2M network; a second communication unit for exchanging data with a predetermined server; a storage unit for receiving information about the use of content being consumed in the content terminal from the content terminal via the first communication unit and storing it; and a control unit for sending the received information about the use of content to a predetermined server via the second communication unit, thereby allowing the information about the use of content to be stored in the server.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a network system according to an embodiment of the present invention;

FIG. 2 is a diagram showing a process of sharing information about the use of content according to an embodiment of the present invention information;

FIG. 3 is a diagram showing an apparatus for sharing information about the use of content according to an embodiment of the present invention;

FIG. 4 is a diagram showing the configuration of information about the use of content according to an embodiment of the present invention;

FIG. 5 is a diagram showing a personalized advertisement screen according to an embodiment of the present invention;

FIG. 6 is a diagram showing a personalized message according to an embodiment of the present invention;

FIG. 7 is a flowchart showing a method of sharing the information about the use of content of a first user terminal according to an embodiment of the present invention;

FIG. 8 is a flowchart showing a method by which a second user terminal shares information about the use of content according to an embodiment of the present invention; and

FIG. 9 is a flowchart showing a method by which a server shares information about the use of content according to an embodiment of the present invention.

### DESCRIPTION OF THE PREFERRED EMBODIMENTS

Reference now should be made to the drawings, throughout which the same reference numerals are used to designate the same or similar components.

Embodiments of the present invention will be described in detail below with reference to the accompanying drawings.

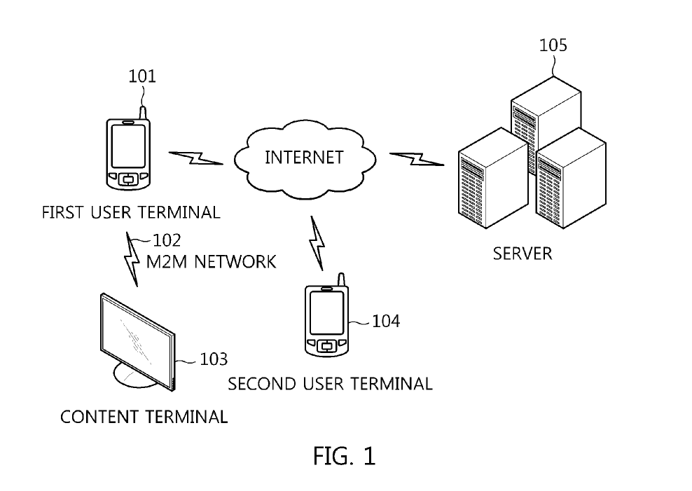

FIG. 1 is a diagram showing a network system according to an embodiment of the present invention.

In accordance with this embodiment, a content terminal 103, such as a television set or a computer, transmits information about the use of content, including information about content currently being consumed, to its surroundings over a machine-to-machine communication network 102 including a short-distance network such as a Bluetooth network or a WLAN.

Machine-to-machine (M2M) communication refers to a future broadcasting-communication convergence information and communications technology (ICT) infrastructure that enables an intelligent communication service to be safely and conveniently used between a human and an object or between an object and another object ubiquitously. Accordingly, M2M communication enables a machine to perform a task that is too risky for a human to manually perform, a task consuming a long time or a task requiring security, and may be applied to the fields of telematics, sports, navigation, smart measuring instruments, automatic vending machines, security services and the like.

In this case, a first user terminal 101 may receive the information about the use of content transmitted from the content terminal, and then transmit and store the received information to and in an external server 105. Furthermore, a user may add an evaluation score, a comment or a tag to information about the content, and then send the information about the content. The stored information is disclosed to the user's acquaintances, and an acquaintance who has viewed this may establish communication via the second user terminal 104 and send a message.

Accordingly, the user may share information about content that he or she him or herself is using with another user, and the other user can be made aware of information about the content being used by the user. In the subsequent drawings, configurations for information about the use of content will be described in greater detail below.

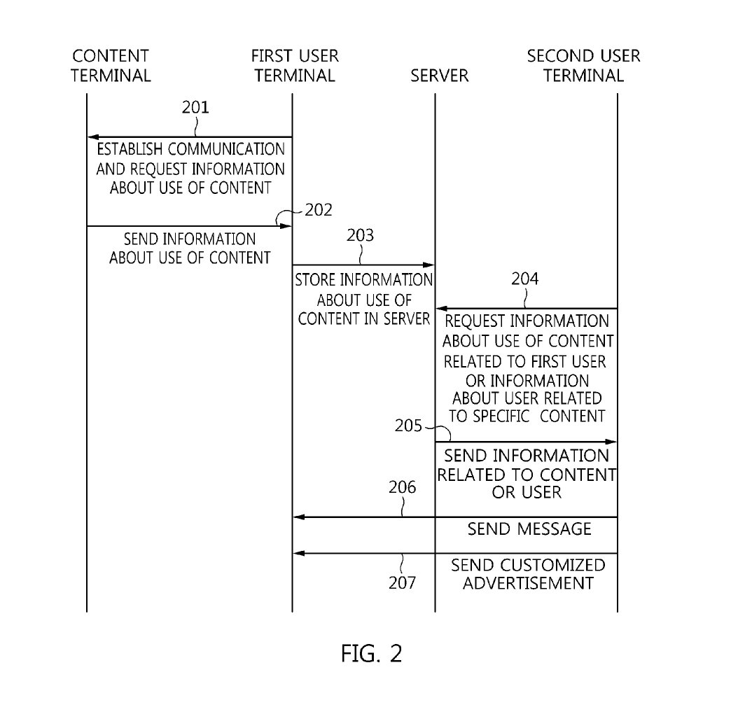

FIG. 2 is a diagram showing a process of sharing information about the use of content according to an embodiment of the present invention.

In accordance with this embodiment, when the first user terminal 101 sends a signal requesting the establishment of communication and information about the use of content to the at least one content terminal 103 at step 201, communication is established between the content terminal 103 and the first user terminal 101 via the M2M network 102.

Thereafter, the content terminal 103 sends information about the use of content related to content being consumed in the content terminal 103 to the first user terminal at step 202, and the first user terminal 101 may store the received information about the use of content.

Furthermore, the first user terminal 101 sends the stored information about the use of content to the server 105 over the Internet, so that the information about the use of content can be stored in the server 105 at step 203.

Furthermore, at step 204, the second user terminal 104 may request information about the use of content related to a first user or information about a user related to specific content from the server 105 in which the information about the use of content has been stored.

That is, in accordance with an embodiment, the second user terminal 104 may receive a query corresponding to specific content, and send a signal to the server 105 to request the information using the received query as a keyword.

Furthermore, in accordance with another embodiment, the second user terminal 104 may receive a query corresponding to a specific user, and send a signal to the server 105 to request the information using the received query as a keyword.

Accordingly, the server 105 may send all or part of the stored information about the use of content to the second user terminal 104 in response to the signal requesting the information at step 205.

Thereafter, the user of the second user terminal 104 may create a message based on the received information about the use of content and send the message to the first user terminal 101 over the Internet at step 206.

Furthermore, in accordance with another embodiment, if the second user terminal 104 is the terminal of an advertiser, the advertiser may transfer a customized advertisement to a user via a user terminal based on the disclosed information at step 207.

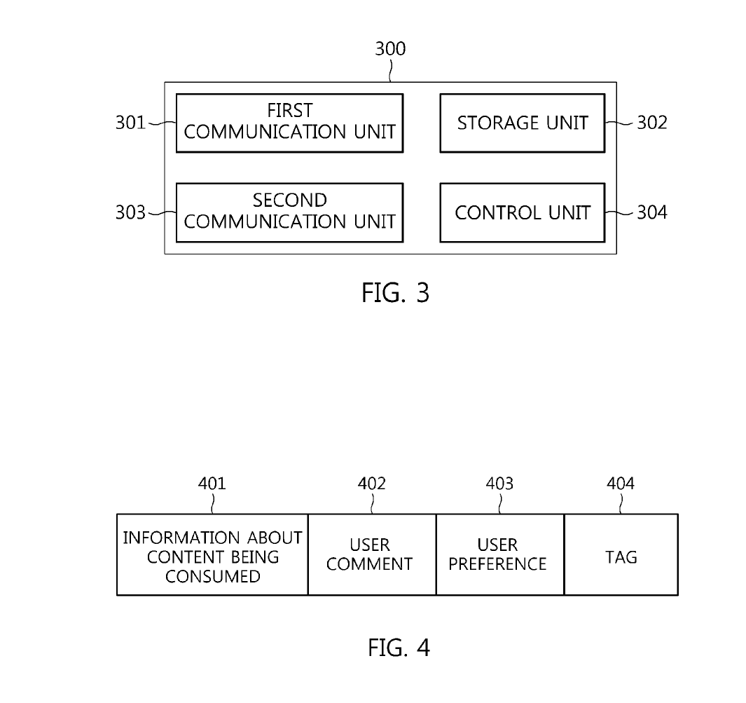

FIG. 3 is a diagram showing an apparatus for sharing information about the use of content according to an embodiment of the present invention.

In accordance with this embodiment, the first user terminal 101 of FIGS. 1 and 2 may correspond to the apparatus 300 for sharing the information about the use of content, and the apparatus 300 for sharing information about the use of the content includes a first communication unit 301, a storage unit 302, a second communication unit 303, and a control unit 304.

In accordance with this embodiment, the first communication unit 301 may establish communication between the at least one content terminal 103 and the first user terminal 101 using the M2M network.

Furthermore, the first communication unit 301 may include a short-distance network such as a Bluetooth network or a WLAN, and perform wired/wireless home networking-based communication.

In accordance with this embodiment, the storage unit 302 may receive information about the use of content related to content being consumed in the content terminal 103 from the content terminal via the first communication unit 101, and store it. Furthermore, the storage unit 302 may be configured in a variety of forms, such as a ROM form, a RAM form and a flash memory form, and may be configured in a buffer form.

In accordance with an embodiment, the second communication unit 303 may send and receive data to and from a predetermined server. Furthermore, the second communication unit 303 may perform Internet networking-based communication.

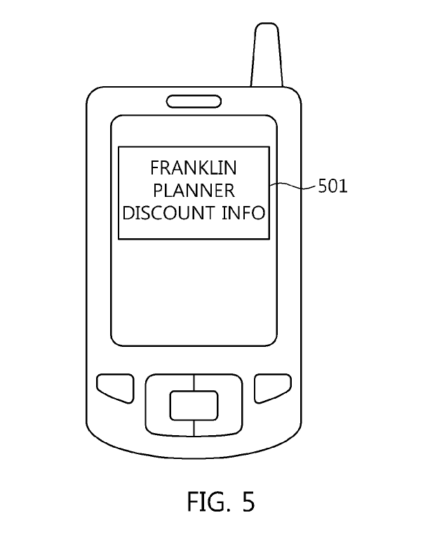

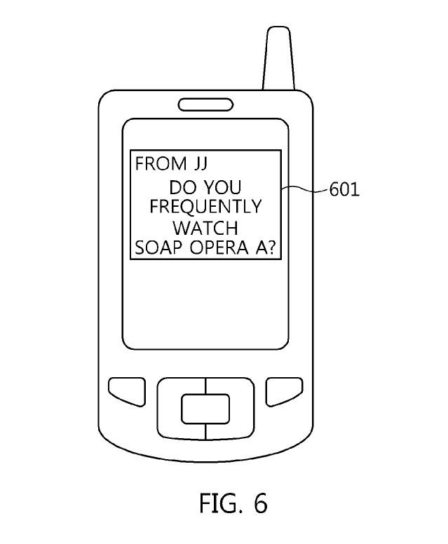

Furthermore, in accordance with another embodiment, the second communication unit 303 may receive an advertisement created based on the information about the use of content or a message based on information about the use of content stored in the server. The advertisement and the message will be described in detail with reference to FIGS. 5 and 6.

Furthermore, in accordance with another embodiment, the second communication unit 303 may establish communication with an external user terminal over the Internet.

In accordance with an embodiment, the control unit 304 may perform control so that the received information about the use of content is sent to the predetermined server via the second communication unit 104, so that the information about the use of content can be stored in the server.

Furthermore, in accordance with another embodiment, the control unit 304 may include user created data corresponding to any one of a user comment, a user preference, and a tag in the information about the use of content and then send the information. The configuration of the information about the use of content will be described in detail with reference to FIG. 4.

The information about the use of content sent to the server may be sent to the external user terminal, and a search may be performed using a query, input to the external user terminal and adapted to specific content, as a keyword or using a query, input to the external user terminal and adapted to a specific user, as a keyword.

Furthermore, the settings may be chosen such that the information about the use of content can be sent only to an external user terminal having the right to access the information about the use of content.

That is, using this, the user can share information about content being consumed by him or her with surrounding acquaintances connected over a network in real time.

FIG. 4 is a diagram showing the configuration of information about the use of content according to an embodiment of the present invention.

In accordance with an embodiment, the information about the use of content may include information about content being consumed 401, a user comment 402, a user preference 403, and a tag 404.

The information about content being consumed 401 may include information about content being consumed in the content terminal 103, and may include information about a content name, a genre, the time, and a creator.

The user comment 402 may include a comment that is input for each piece of content by the user. That is, using this configuration, each user may share a message regarding his or her subjective sentiment with other users.

The user preferences 403 may include information about the evaluation score of each user for each piece of content. That is, using this, each user can obtain information about which user prefers which content.

The tag 404 may include keywords that are of the kind formed by a content creator inputting words indicative of his or her sentiment, situation and intention in order to search for the content. Furthermore, the tag 404 may include information about content associated with each piece of content.

That is, using information included in the information about the use of content, users can share a variety of information required to create a message or advertisement information as well as sharing the name of content and information about whether the content is being used.

FIG. 5 is a diagram showing a personalized advertisement screen according to an embodiment of the present invention.

In accordance with an embodiment, a user terminal that has received an advertisement 501 created based on information about the use of content may display the received advertisement 501.

That is, an advertiser may create a personalized advertisement based on information included in the information about the use of content, and the created advertisement is displayed on the user terminal, thereby improving the advertising effects.

For example, if a specific user chiefly uses content related to news, current affairs and business via the content terminal 103, an advertisement for the product “Franklin Planner” related to the user's business environment may be created based on the information about the use of content, and then the created advertisement is sent to the specific user's user terminal, so that it can be displayed on the user terminal.

FIG. 6 is a diagram showing a personalized message according to an embodiment of the present invention.

In accordance with an embodiment, the user terminal that has received a message 601 created based on information about the use of content may display the received message 601.

That is, using information included in the information about the use of content, some other user may determine content that is being used by a user who has sent the information about the use of content, and create and send a message based on the determination.

For example, if a specific user chiefly uses content related to soap opera A via the content terminal 103 and information about the use of content is created and sent to a server, some other user may become aware that the specific user frequently uses content related to soap opera A, create the message “do you frequency watch soap opera A?,” and send the message to the user terminal of the specific user, so that it can be displayed thereon.

That is, using this, social networking between users can be enhanced.

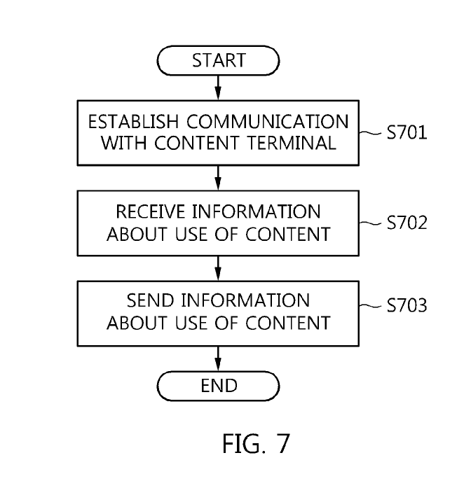

FIG. 7 is a flowchart showing a method of sharing the information about the use of content of the first user terminal 101 according to an embodiment of the present invention.

In accordance with an embodiment, the first user terminal 101 may correspond to an apparatus for sharing information about the use of content.

Accordingly, the first user terminal 101 establishes communication with the content terminal 103 at step S701. That is, in accordance with an embodiment, communication between the at least content terminal 103 and the first user terminal 101 is established via the M2M network 102.

Thereafter, information about the use of content related to content being consumed in the content terminal 103 is received from the content terminal 103 at step S702.

Thereafter, the received information about the use of content may be sent to a predetermined server over the Internet, so that the information about the use of content can be stored in the server at step S703.

In accordance with an embodiment, the information about the use of content may include user created data, that is, any one of a user comment, a user preference, and a tag.

Furthermore, data related to a message or an advertisement created based on the sent information about the use of content may be received, and then the message or advertisement may be displayed.

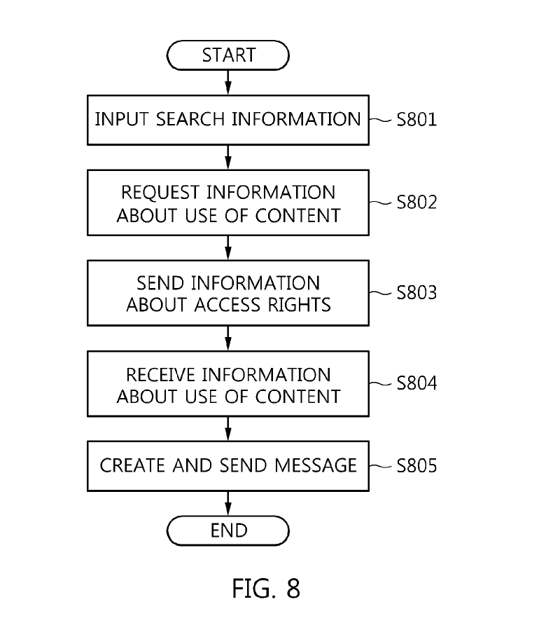

FIG. 8 is a flowchart showing a method by which the second user 104 terminal shares information about the use of content according to an embodiment of the present invention.

In accordance with an embodiment, the second user terminal 104 may include at least one external user terminal that is different from the first user terminal 101 or the apparatus for sharing information about the use of content.

First, the second user terminal 104 receives search information at step S801.

In accordance with an embodiment, the search information may simply include search information for the overall information about the use of content. In accordance with another embodiment, the search information may include a query corresponding to specific content or a query corresponding to a specific user.

Thereafter, the second user terminal 104 may request information about the use of content from a server at step S802. That is, the second user terminal 104 may send a request signal over the Internet server.

Furthermore, the second user terminal may send information about the right to access the server at step S803. That is, if the settings have been chosen such that only one or more specific user terminals can access the information about the use of content, information about the access rights may be sent to certify that the second user terminal 104 corresponds to one of the external user terminals.

Thereafter, the second user terminal 104 receives information about the use of content at step S804.

In accordance with an embodiment, the received information about the use of content may be overall information about the use of content. In accordance with another embodiment, only a part corresponding to specific content or a specific user may be sent from the server and then be received by the second user terminal 104.

Thereafter, the second user terminal 104 creates a message or an advertisement based on the received information about the use of content, and sends the created message or advertisement to the first user terminal over the Internet, thereby achieving the object of the present invention at step S805.

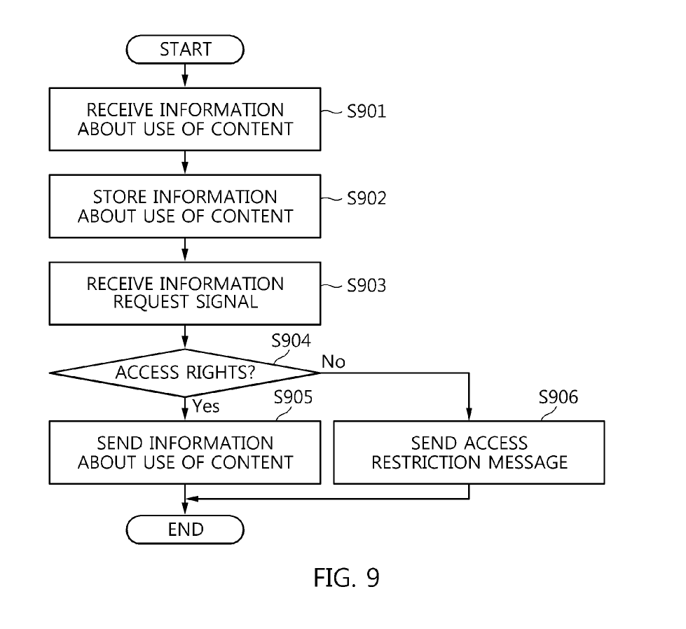

FIG. 9 is a flowchart showing a method by which the server 105 shares information about the use of content according to an embodiment of the present invention.

In accordance with an embodiment, the server 105 may include a server that is operated by an advertiser or a communication service provider. In accordance with another embodiment, the server 105 may be included in and operate inside the first user terminal 101 or the second user terminal 104.

First, the server 105 receives information about the use of content from the first user terminal 101 at step S901, and stores the received information about the use of content in a storage space at step S902.

Thereafter, when the information request signal is received from the second user terminal 104 at step S903, it is determined whether the second user terminal 104 that has sent the information request signal has the right to access the information about the use of content at step at step S904. Furthermore, in accordance with another embodiment, if the overall information about the use of content has been disclosed, the determination step S904 may be omitted.

Thereafter, if it is determined that the second user terminal 104 has access rights, the information about the use of content is sent to the second user terminal 104 at step S905. In accordance with an embodiment, the information about the use of content may be overall information about the use of content received from the first user terminal 101. If the information request signal requests part of the information about the use of content, only the part of the information about the use of content may be sent in response to the request.

In contrast, if it is determined that the second user terminal 104 does not have the right to access, an access restriction message is sent to the second user terminal 104 and the process is terminated at step S906. That is, the information about the use of content may be provided to only a limited number of external users.

Accordingly, using the sequences of FIGS. 7 to 9, the devices of the network for sharing information about the use of content can operate in a cooperative manner, via which the users can share the information about the use of content.

In accordance with the present invention, the user can share information about content being consumed by himself or herself with surrounding acquaintances connected over a network in real time, so that the user's satisfaction with the use of content can be improved. Furthermore, another user or an advertiser can send a message or advertisement screen using the shared information about the use of content, and therefore the advantage of improving the familiarity between users or the advantage of increasing advertising effects can be achieved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of sharing information about use of content, comprising:
establishing, by a first user terminal, communication between at least one content terminal and the first user terminal over a machine-to-machine (M2M) network;
receiving, by the first user terminal, information about use of content being consumed in the content terminal from the content terminal; and
sending, by the first user terminal, the received information about the use of content to a predetermined server over an Internet, thereby allowing the information about the use of content to be stored in the predetermined server.

2. The method as set forth in claim 1, wherein the sending, by the first user terminal, the received information about the use of content to a predetermined server comprises sending, by the first user terminal, the information about the use of content, including user created data, that is, any one of a user comment, a user preference and a tag, to the predetermined server.

3. The method as set forth in claim 1, further comprising receiving, by the first user terminal, advertisement information created based on the information about the use of content stored in the predetermined server.

4. The method as set forth in claim 1, wherein the sending, by the first user terminal, the received information about the use of content to a predetermined server comprises sending, by the first user terminal, the information about the use of content that can be sent to a second user terminal, to the predetermined server.

5. The method as set forth in claim 4, wherein the sending, by the first user terminal, the received information about the use of content to a predetermined server comprises sending, by the first user terminal, the information about the use of content that can be searched using a query corresponding to specific content input to the second user terminal as a keyword, to the predetermined server.

6. The method as set forth in claim 4, wherein the sending, by the first user terminal, the received information about the use of content to a predetermined server comprises sending, by the first user terminal, the information about the use of content that can be searched using a query corresponding to a specific user input to the second user terminal as a keyword, to the predetermined server.

7. The method as set forth in claim 4, further comprising establishing, by the first user terminal, communication with the second user terminal; and
exchanging, by the first user terminal, a predetermined message with the second user terminal with which the communication has been established.

8. The method as set forth in claim 4, wherein the sending, by the first user terminal, the received information about the use of content to a predetermined server comprises sending, by the first user terminal, the information about the use of content that can be sent only to the second user terminal having a right to access the information about the use of content, to the predetermined server.

9. The method as set forth in claim 7, further comprising receiving, by the first user terminal, advertisement information created based on the message exchanged between the first user terminal and the second user terminal.

10. An apparatus for sharing information about use of content, comprising:
a first communication unit for establishing communication between at least one content terminal and a first user terminal over an M2M network;
a second communication unit for exchanging data with a predetermined server;
a storage unit for receiving information about the use of content being consumed in the content terminal from the content terminal via the first communication unit and storing it; and
a control unit for sending the received information about the use of content to a predetermined server via the second communication unit, thereby allowing the information about the use of content to be stored in the predetermined server.

11. The apparatus as set forth in claim 10, wherein:
the first communication unit performs home networking-based communication; and
the second communication unit performs Internet networking-based communication.

12. The apparatus as set forth in claim 10, wherein the control unit includes user created data, that is, any one of a user comment, a user preference and a tag, in the information about the use of content and then sends the information about the use of content.

13. The apparatus as set forth in claim 10, wherein the second communication unit receives advertisement information created based on the information about the use of content stored in the predetermined server.

14. The apparatus as set forth in claim 10, wherein the control unit sends the information about the use of content that can be sent to an external user terminal, to the predetermined server.

15. The apparatus as set forth in claim 14, wherein the control unit sends the information about the use of content that can be searched using a query corresponding to specific content input to the external user terminal as a keyword, to the predetermined server.

16. The apparatus as set forth in claim 14, wherein the control unit sends the information about the use of content that can be searched using a query corresponding to a specific user input to the external user terminal as a keyword, to the predetermined server.

17. The apparatus as set forth in claim 14, wherein:
the second communication unit establishes communication with the external user terminal; and
the control unit exchanges a predetermined message with the external user terminal with which communication has been established via the second communication unit.

18. The apparatus as set forth in claim 14, wherein the control unit sends the information about the use of content that can be sent only to the external user terminal having a right to access the information about the use of content, to the predetermined server.

19. The apparatus as set forth in claim 17, wherein the second communication unit receives advertisement information created based on the message exchanged with the external user terminal.
